(19) United States
(12) Patent Application Publication
(10) Pub. No.: US 2013/0255992 A1
(43) Pub. Date: Oct. 3, 2013

(54) INSULATED WIRE

(71) Applicant: HITACHI CABLE, LTD., Tokyo (JP)

(72) Inventors: Takanori YAMAZAKI, Mito (JP); Hideto MOMOSE, Hitachiota (JP); Toshiharu GOTO, Takahagi (JP); Junichi ABE, Hitachi (JP); Shigehiro MORISHITA, Hitachi (JP)

(73) Assignee: HITACHI CABLE, LTD., Tokyo (JP)

(21) Appl. No.: 13/764,118

(22) Filed: Feb. 11, 2013

(30) Foreign Application Priority Data
Mar. 28, 2012 (JP) 2012-072814

(51) Int. Cl. H01B 3/30

(52) U.S. Cl. CPC H01B 3/301
USPC 174/120 SR

(57) ABSTRACT

An insulated wire includes a conductor and an insulation covering formed thereon. The insulation covering includes a first insulation covering layer formed directly on the conductor and a second insulation covering layer formed on a periphery of the first insulation covering layer. The first insulation covering layer includes a resin composition including a resin (A) including polyphenylene sulfide and a resin (B) including polyamide mixed at a mass ratio in a range of “30/70≦B/A≦90/10”. The second insulation covering layer includes a resin composition mainly including a resin (C) including polyphenylene sulfide or polyetheretherketone.

The present application is based on Japanese patent application No. 2012-072814 filed on Mar. 28, 2012, the entire contents of which are incorporated herein by reference.

### BACKGROUND OF THE INVENTION

1. Field of the Invention

The invention relates to an insulated wire used for a coil of electric equipment such as rotating machine or transformer and, in particular, to an insulated wire having an insulation covering including an extruded covering layer.

2. Description of the Related Art

An insulated wire (enamel-covered insulated wire) used for a coil of electric equipment such as rotating machine or transformer generally has a structure in which a single or plural layers of insulation coverings are formed on an outer periphery of a conductor having a cross sectional shape which is suitable for the intended use and matches a shape of a coil (e.g., a round shape or a rectangular shape). A method of forming such an insulation covering includes a method in which an insulating coating material formed by dissolving a resin in an organic solvent is applied and baked on a conductor and a method in which a pre-mixed resin composition is extruded on a conductor.

In recent years, the insulated wire is wound onto a small diameter core at high density under high tension in a coil winding process in order to meet a demand for size reduction of electric equipments, and the insulation covering is required to have mechanical characteristics (e.g., adhesion and abrasion resistance, etc.) to withstand severe processing stress. In addition, inverter control and use at higher voltage have been developed in order to meet demands for higher efficiency and higher output of electric equipments. As a result, an operating temperature of a coil tends to be higher than before and the insulation covering is thus required to have high heat resistance. In addition to this, there is a problem that the insulation covering may be deteriorated/damaged due to occurrence of partial discharge since higher voltage such as inverter surge voltage is applied to the coil in the electric equipment.

In order to prevent deterioration/damage of the insulation covering caused by the partial discharge, an insulation covering with high partial discharge inception voltage is being developed. Examples of means to increase the partial discharge inception voltage of the insulation covering include a method in which a resin having a low relative dielectric constant is used for an insulation covering and a method in which an insulation covering is thickened.

For example, an insulation covering material for a winding wire containing a fluorine-based polyimide resin with a specific structure is disclosed in JP-A-2002-056720. The insulation covering material described in JP-A-2002-056720 has a relative dielectric constant of 2.3 to 2.8 which is significantly lower than that of a conventional insulating coating material (about 3 to 4), and as a result, heat generation in the insulation covering is suppressed and deterioration caused by the heat is thus suppressed.

Japanese patent No. 4177295 discloses an inverter surge resistant insulated wire having at least one baked enamel layer on an outer periphery of a conductor and at least one extrusion-coated resin layer on the outer side thereof, wherein the total thickness of the baked enamel layer and the extrusion-coated resin layer is not less than 60 μm, the thickness of the baked enamel layer is not more than 50 μm, and the extrusion-coated resin layer is formed of a resin material (excluding polyetheretherketone) having a tensile elastic modulus at 25° C. of not less than 1000 MPa and a tensile elastic modulus at 250° C. of not less than 10 MPa. According to Japanese patent No. 4177295, it is possible to provide an insulated wire having high partial discharge inception voltage (about 900 Vp) without decreasing bond strength between the conductor and the insulation covering layer.

Meanwhile, JP-A1-2005-106898 discloses a multilayer insulated wire having two or more layers and composed of a conductor and extruded insulation layers covering the conductor, wherein at least one of the insulation layers excluding the innermost layer is formed of a resin mixture containing a polyphenylene sulfide resin as a continuous phase and an olefin-based copolymer component as a dispersed phase, and the insulation layer formed of the resin mixture contains 100 parts by mass of the polyphenylene sulfide resin and 3 to 40 parts by mass of the olefin-based copolymer component. The insulated wire disclosed in JP-A1-2005-106898 is excellent in heat resistance and chemical resistance.

### SUMMARY OF THE INVENTION

In case that an insulating coating material made of the fluorine-based polyimide resin as described in JP-A-2002-056720 is used to form an insulation covering, it is considered that it is possible to reduce a relative dielectric constant of the insulation covering per se. However, since the insulation covering formed of the fluorine-based polyimide resin has low adhesion to the conductor, there is a concern that a phenomenon in which the insulation covering is separated from the conductor due to severe processing stress during, e.g., a coil winding process, etc., (looseness of cover) occurs. The looseness of cover is a cause of decreasing partial discharge inception voltage of the insulated wire as a whole.

In the conventional insulated wire having an extrusion-coated resin layer as described in Japanese patent No. 4177295, it is considered that partial discharge inception voltage can be increased by thickening the extrusion-coated resin layer and, in order to ensure adhesion to the extrusion-coated resin layer, the baked enamel layer is interposed between the conductor and the extrusion-coated resin layer. In addition, in Japanese patent No. 4177295, an adhesive layer is further interposed between the baked enamel layer and the extrusion-coated resin layer as a preferred embodiment to strengthen adhesion between the baked enamel layer and the extrusion-coated resin layer.

However, since the properties of a resin composition and a forming method are greatly different between the baked enamel layer and the extrusion-coated resin layer, the insulated wire in Japanese patent No. 4177295 has problems that the manufacturing process is likely to be complicated and the manufacturing cost tends to increase. In addition, when the adhesive layer is further interposed between those layers, there is a problem that the manufacturing cost further increases.

Meanwhile, the conventional multilayer insulated wire as described in JP-A1-2005-106898 does not necessarily meet the recent demand for partial discharge inception voltage (as an example, not less than 1700 Vp in a room temperature environment). In other words, further improvement in partial discharge inception voltage of the insulated wire is strongly desired.

As described above, an operating temperature of a coil (i.e., working temperature of the insulated wire) tends to be higher than before. On the other hand, a dielectric constant of the resin material generally increases with a temperature rise. Accordingly, in addition to improvement for use in the room temperature environment, the insulated wire having high partial discharge inception voltage even in a high-temperature environment (e.g., 150° C.) is required in order to accommodate the latest actual use environment.

Accordingly, it is an object of the invention to provide an insulated wire that has higher partial discharge inception voltage than before in a wide temperature range while securing the same adhesion as the conventional insulated wire between a conductor and an insulation covering (i.e., without decreasing the adhesion between the conductor and the insulation covering).

(1) According to one embodiment of the invention, an insulated wire comprises:

a conductor, and

an insulation covering formed thereon,

wherein the insulation covering comprises:

a first insulation covering layer formed directly on the conductor and a second insulation covering layer formed on a periphery of the first insulation covering layer,

wherein the first insulation covering layer comprises a resin composition comprising a resin (A) comprising polyphenylene sulfide and a resin (B) comprising polyamide mixed at a mass ratio in a range of “30/70≦B/A≦90/10”, and

wherein the second insulation covering layer comprises a resin composition mainly comprising a resin (C) comprising polyphenylene sulfide or polyetheretherketone.

In the above embodiment (1) of the invention, the following modifications and changes can be made.

(i) The resin composition of the second insulation covering layer further comprises a resin (D) comprising polyamide mixed in an amount of not more than 5 parts by mass relative to the resin (C).

(ii) The resin composition of the second insulation covering layer further comprises a resin (E) comprising polyolefin having a relative dielectric constant of less than 3.0 mixed to the resin (C) at a mass ratio of “5/95≦E/C≦50/50”.

(iii) The polyamide of the resin (B) has a melting point of not less than 280° C.

(iv) The polyamide of the resin (B) and the resin (D) has a melting point of not less than 280° C.

(v) The resin (B) comprises one of nylon 46, nylon 6T, nylon 6I, nylon 9T and nylon M5T.

(vi) The resin (B) and the resin (D) each comprise one of nylon 46, nylon 6T, nylon 6I, nylon 9T and nylon M5T.

(vii) The first insulation covering layer is formed on the conductor being heated to not less than 250° C.

(viii) The resin (E) comprises one of polyethylene, ethylene-vinyl acetate copolymer, ethylene-ethyl acrylate copolymer, ethylene methyl acrylate copolymer, ethylene-glycidyl methacrylate copolymer, isotactic polypropylene, syndiotactic polypropylene and polymethylpentene.

(ix) The resin (A) is 10 parts to 70 parts by mass included in the first insulation covering layer.

(x) The resin (C) is included 50 parts to 100 parts by mass in the second insulation covering layer.

### Effects of the Invention

According to one embodiment of the invention, an insulated wire can be provided that has higher partial discharge inception voltage than before in a wide temperature range while securing the same adhesion as the conventional insulated wire between a conductor and an insulation covering (i.e., without decreasing the adhesion between the conductor and the insulation covering).

### BRIEF DESCRIPTION OF THE DRAWINGS

Next, the present invention will be explained in more detail in conjunction with appended drawings, wherein:

FIG. 1 is a schematic cross sectional view showing an example of an insulated wire in an embodiment of the present invention.

### DETAILED DESCRIPTION OF THE PREFERRED EMBODIMENTS

The present inventors intensively studied a resin composition and a structure of an insulation covering layer in order to suppress partial discharge of an insulated wire in a wide temperature range. As a result, it was found that it is effective when the insulation covering layer is composed of at least two layers such that a resin composition containing a resin (A) made of polyphenylene sulfide and a resin (B) made of polyamide mixed at a predetermined mass ratio is used for a first insulation covering layer formed directly on the conductor (i.e., the first insulation covering layer being formed directly contacting the conductor), and a resin composition consisting mainly of a resin (C) made of polyphenylene sulfide or polyetheretherketone is used for a second insulation covering layer further formed on the outside of the first insulation covering layer. The invention was made based on these findings.

An embodiment of the invention will be described below. Note that, the invention is not limited to the embodiment described herein and appropriate combinations and modifications can be made without departing from the gist of the invention.

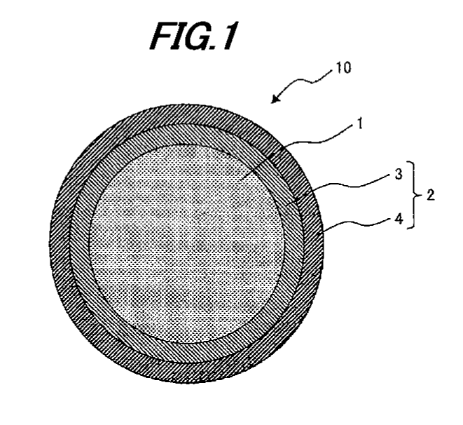

FIG. 1 is a schematic cross sectional view showing an example of an insulated wire in the embodiment of the invention. As shown in FIG. 1, in an insulated wire 10 of the invention, an insulation covering 2 is formed on a conductor 1 and has a first insulation covering layer 3 formed directly on the conductor 1 and a second insulation covering layer 4 formed on the outside of the first insulation covering layer 3.

As described above, the first insulation covering layer 3 is formed of a resin composition containing a resin (A) made of polyphenylene sulfide and a resin (B) made of polyamide mixed thereto, and a mixture ratio (a mass ratio) of the resin (A) to the resin (B) is preferably within a range of “30/70≦B/A≦90/10”. Such a configuration can provide good adhesion between the conductor 1 and the first insulation covering layer 3.

The resin (A) made of polyphenylene sulfide has high heat resistance and high mechanical characteristics but may not have sufficient adhesion to the conductor by itself Accordingly, a resin composition containing the resin (B) made of polyamide which is mixed to improve adhesion to the conductor was examined. When a mass ratio of the resin (A) to the resin (B) is “B/A<30/70”, the amount of the resin (B) is too small and a sufficient effect of improving adhesion to the conductor is not obtained. On the other hand, when the mass ratio is “B/A>90/10”, the amount of the resin (B) is too large and influence of a polar group in a molecular structure of polyamide relatively increases, which causes a decrease in partial discharge inception voltage.

In the invention, the second insulation covering layer 4 which is formed of a resin composition consisting mainly of a resin (C) made of polyphenylene sulfide or polyetheretherketone is further provided on the outside of the first insulation covering layer 3. By providing the second insulation covering layer 4 in addition to the first insulation covering layer 3, it is possible to achieve higher partial discharge inception voltage than the conventional technique (e.g., high partial discharge inception voltage of not less than 1700 Vp) without decreasing adhesion.

In the resin composition constituting the second insulation covering layer 4, it is preferable that a resin (D) made of polyamide be mixed in an amount of not more than 5 parts by mass with respect to the resin (C). Mixing the resin (D) suppresses an increase in a relative dielectric constant accompanied by a temperature rise and it is effective to maintain high partial discharge inception voltage in a wide temperature range without decreasing adhesion. If the mixture ratio of the resin (D) is more than 5 parts by mass with respect to the resin (C), the relative dielectric constant of the second insulation covering layer 4 increases (e.g., not less than 3.0) and high partial discharge inception voltage may not be obtained.

In addition, in the resin composition constituting the second insulation covering layer 4, it is preferable that a resin (E) made of polyolefin having a relative dielectric constant of less than 3.0 be mixed to the resin (C) at a mass ratio within a range of “5/95≦E/C≦50/50”. Mixing the resin (E) decreases the relative dielectric constant of the second insulation covering layer 4 and it is thus possible to increase partial discharge inception voltage. When the mass ratio of the resin (C) to the resin (E) is “E/C<5/95”, the amount of the resin (E) is too small and an effect of increasing partial discharge inception voltage is not sufficiently obtained. On the other hand, when the mass ratio is “E/C>50/50”, the amount of the resin (E) is too large and heat resistance decreases.

It is preferable that a resin made of polyamide having a melting point of not less than 280° C. be used as the resin (B) and the resin (D). The polyamide having a melting point of not less than 280° C. includes, e.g., nylon 46 which is aliphatic polyamide, or nylon 6T (co-condensation polymer of hexamethylenediamine and terephthalic acid), nylon 6I (co-condensation polymer of hexamethylenediamine and isophthalic acid), nylon 9T (co-condensation polymer of nonanediamine and terephthalic acid), nylon M5T (co-condensation polymer of methylpentadiamine and terephthalic acid), nylon 6T/66 (copolymer of nylon 6T and nylon 66), nylon 6T/6I (copolymer of nylon 6T and nylon 6I), nylon 6T/6I/66 (copolymer of nylon 6T, nylon 6I and nylon 66), nylon 6T/M5T (copolymer of nylon 6T and nylon M5T) and nylon 6T/6 (copolymer of nylon 6T and nylon 6), etc., which are aromatic polyamide. For the resin (B) and the resin (D), the above-mentioned polyamide may be used alone or in a combination of plural types. In addition, the resin (B) and the resin (D) may be the same or different from each other.

As the resin (E), for example, a resin (El) formed of an ethylene copolymer selected from the group consisting of polyethylene, ethylene-vinyl acetate copolymer, ethylene-ethyl acrylate copolymer, ethylene methyl acrylate copolymer and ethylene-glycidyl methacrylate copolymer and a resin (E2) selected from the group consisting of isotactic polypropylene, syndiotactic polypropylene and polymethylpentene are preferably used. Alternatively, a resin (E3) formed by modifying the resin (E1) or the resin (E2) with maleic anhydride and/or glycidyl methacrylate may be used. One of the resins (E1) to (E3) may be used alone, or a combination of plural types may be used.

In a method of manufacturing an insulated wire in the invention, it is preferable that the first insulation covering layer 3 be formed on the conductor 1 by extrusion coating. It is especially preferable that the first insulation covering layer 3 be extruded in a state that the conductor 1 is heated to not less than 250° C. This further improves adhesion between the conductor 1 and the first insulation covering layer 3. By improving adhesion, a crease can be prevented from occurring even when the insulated wire 10 is bent at small diameter (e.g., self-diameter) and abrasion resistance is also improved.

The means of heating the conductor 1 is not specifically limited and it is possible to use an electric furnace, a burner, a warm air heater or an induction heating apparatus, etc. It is highly effective when the heating temperature is 100° C. or more higher than the glass-transition temperature (Tg) of a resin composition to be extruded and is also not less than 250° C. as a temperature at which the resin composition starts to melt. The heating temperature is not specifically limited but is preferably maintained for few seconds to few minutes. Note that, when the heating temperature is less than 250° C., the further effect by the heat treatment is not obtained.

Although the method of forming the second insulation covering layer 4 is not specifically limited, it is preferable that the second insulation covering layer 4 be also formed by extrusion coating (e.g., co-extrusion or tandem extrusion) in view of simplification of the manufacturing process.

Although the thickness of the insulation covering 2 is not specifically limited, not less than 100 μm is preferable. A resin composition formed by modifying a polyolefin-based resin with maleic anhydride or glycidyl methacrylate may be blended as a sub-material to the above-mentioned resin composition in order to improve flexibility of the insulation covering 2. In addition, an antioxidant, copper inhibitor, lubricant and colorant, etc., may be added to the above-mentioned resin composition when needed, and a lubricant layer may be separately formed on the outer periphery of the second insulation covering layer 4.

The material of the conductor 1 is not specifically limited and it is possible to use materials which are commonly used for an enamel-covered insulated wire (e.g., oxygen-free copper and low oxygen copper, etc.). Although the conductor 1 having a circular cross section is shown as an example in FIG. 1, it is not limited thereto and the conductor may have a rectangular shape. It should be noted that the rectangular shape in the invention includes a rectangle with rounded corners or a rounded rectangle.

### EXAMPLES

Although the invention will be described below based on Examples, the invention is not limited thereto. Note that, components of the resin compositions constituting insulation coverings in Examples 1 to 12 are shown in Tables 1 and 2 below, and those in Comparative Examples 1 to 4 are shown in Table 3 below.

### Preparation of Examples 1 to 12 and Comparative Examples 1 to 4

A copper wire having an outer diameter of 1.25 mm was used as a conductor and each resin composition shown in Tables 1 to 3 below was extruded on the outer periphery of the copper wire by an extruder, thereby making an insulated wire having a shape shown in FIG. 1. High-density polyethylene (HDPE) in Tables has a density of 0.91 g/cm³ and a melt flow rate (MFR) of 0.8 g/10 min. The thickness of the insulation covering is about 150 μm.

The following measurements and tests were conducted on the insulated wires which were made as described above (Examples 1 to 12 and Comparative Examples 1 to 4).

(1) Measurement of Partial Discharge Inception Voltage

The partial discharge inception voltage was measured by the following procedure.

Two 500 mm-long insulated wires were cut out and were twisted together while applying tension of 39N (4 kgf), thereby preparing a twisted pair sample having six twisted portions within a range of 120 mm at the middle portion. 10 mm of the insulation covering at an end portion of the sample was removed by Abisofix. Then, the sample was kept in a constant-temperature oven at 120° C. for 30 minutes in order to dry the insulation covering and was subsequently left in a desiccator for 18 hours until reaching room temperature. The partial discharge inception voltage was measured using a partial discharge automatic test system (DAC-6024, manufactured by Soken Electric Co., Ltd.). Under the measurement conditions of an atmosphere with a relative humidity of 50% at 25° C. and an atmosphere at 150° C., voltage was applied to the twisted pair sample while increasing the voltage from 50 Hz at 10 to 30 V/s. Voltage at which electric discharge of 50 pC occurs 50 times in the twisted pair sample is defined as the partial discharge inception voltage (Vp).

(2) Evaluation of Adhesion

The adhesion was evaluated by conducting a sudden tensile test in accordance with JIS C 3003. As a result of the sudden tensile test, the sample in which length of looseness (separation) of the insulation covering from a rupture point is not more than 2 mm was evaluated as “⊚: excellent”, 2 to 20 mm was evaluated as “◯: passed the test” and more than 20 mm was evaluated as “×: failed the test”.

Components and measurement evaluation results of Examples 1 to 12 are shown in Tables 1 and 2, and those of Comparative Examples 1 to 4 are shown in Table 3.

TABLE 1
Components of resin and Test evaluation results in Examples 1 to 6

| | | | | Examples | | | | | |
|---|---|---|---|---|---|---|---|---|---|
| | | | | 1 | 2 | 3 | 4 | 5 | 6 |
| Compound | First insulation covering layer | A | Polyphenylene sulfide | 70 | 70 | 70 | 70 | 10 | 10 |
| (parts by mass) | | B | Nylon 46 (melting point: 290° C.) | 30 | 30 | — | — | 90 | 90 |
| | | | Nylon 9T (melting point: 308° C.) | — | — | 30 | 30 | — | — |
| | Second insulation covering | C | Polyphenylene sulfide | 100 | 95 | 95 | 50 | 100 | 95 |
| | layer | D | Nylon 46 (melting point: 290° C.) | — | 5 | — | — | — | 5 |
| | | E | High density polyethylene | — | — | 5 | 50 | — | — |

| B/A | | 30/70 | 30/70 | 30/70 | 30/70 | 90/10 | 90/10 |
|---|---|---|---|---|---|---|---|
| E/C | | — | — | 5/95 | 50/50 | — | — |
| Thickness of Insulation covering (μm) | | 150 | 150 | 150 | 150 | 150 | 150 |
| Conductor temperature at the time of extruding First insulation covering layer (° C.) | | 30 | 150 | 250 | 300 | 30 | 150 |
| Evaluation | Partial discharge inception voltage (Vp, at 25° C.) | 1800 | 1750 | 1850 | 2000 | 1800 | 1700 |
| results | Partial discharge inception voltage (Vp, at 150° C.) | 1600 | 1550 | 1650 | 1800 | 1600 | 1500 |
| | Evaluation of Adhesion | ◯ | ◯ | ⊚ | ⊚ | ◯ | ◯ |

TABLE 2
Components of resin and Test evaluation results in Examples 7 to 12

| | | | | Examples | | | | | |
|---|---|---|---|---|---|---|---|---|---|
| | | | | 7 | 8 | 9 | 10 | 11 | 12 |
| Compound | First insulation covering layer | A | Polyphenylene sulfide | 10 | 10 | 60 | 60 | 60 | 60 |
| (parts by mass) | | B | Nylon 46 (melting point: 290° C.) | — | — | 40 | — | — | — |
| | | | Nylon 9T (melting point: 308° C.) | 90 | 90 | — | 40 | 40 | 40 |
| | Second insulation covering | C | Polyphenylene sulfide | 95 | 50 | 80 | 80 | — | 75 |
| | layer | | Polyetheretherketone | — | — | — | — | 100 | — |
| | | D | Nylon 46 (melting point: 290° C.) | — | — | — | — | — | 5 |

| | | | | | | | |
|---|---|---|---|---|---|---|---|
| E | High density polyethylene | 5 | 50 | 20 | 20 | — | 20 |

| B/A | | 90/10 | 90/10 | 40/60 | 40/60 | 40/60 | 40/60 |
|---|---|---|---|---|---|---|---|
| E/C | | 5/95 | 50/50 | 20/80 | 20/80 | — | 20/75 |
| Thickness of Insulation covering (μm) | | 150 | 150 | 150 | 150 | 150 | 150 |
| Conductor temperature at the time of extruding First insulation covering layer (° C.) | | 250 | 300 | 300 | 300 | 300 | 300 |
| Evaluation | Partial discharge inception voltage (Vp, at 25° C.) | 1800 | 1950 | 1900 | 1900 | 2000 | 1850 |
| results | Partial discharge inception voltage (Vp, at 150° C.) | 1550 | 1700 | 1700 | 1700 | 1850 | 1650 |
| | Evaluation of Adhesion | ⊚ | ⊚ | ⊚ | ⊚ | ⊚ | ⊚ |

TABLE 3
Components of resin and Test evaluation results in Comparative Examples 1 to 4

| | | | | Comparative Examples | | | |
|---|---|---|---|---|---|---|---|
| | | | | 1 | 2 | 3 | 4 |
| Compound | First insulation covering layer | A | Polyphenylene sulfide | 80 | 5 | — | — |
| (parts by mass) | | B | Nylon 46 (melting point: 290° C.) | 20 | 95 | — | — |
| | | | Nylon 9T (melting point: 308° C.) | — | — | 100 | 100 |
| | Second insulation covering | C | Polyphenylene sulfide | 100 | 100 | 95 | 50 |
| | layer | D | Nylon 46 (melting point: 290° C.) | — | — | — | — |
| | | E | High density polyethylene | — | — | 5 | 50 |

| B/A | | 20/80 | 95/5 | — | — |
|---|---|---|---|---|---|
| E/C | | — | — | 5/95 | 50/50 |
| Thickness of Insulation covering (μm) | | 150 | 150 | 150 | 150 |
| Conductor temperature at the time of extruding First insulation covering layer (° C.) | | 30 | 150 | 300 | 300 |
| Evaluation | Partial discharge inception voltage (Vp, at 25° C.) | 1800 | 1550 | 1450 | 1600 |
| results | Partial discharge inception voltage (Vp, at 150° C.) | 1600 | 1400 | 1300 | 1450 |
| | Evaluation of Adhesion | X | ◯ | ⊚ | ⊚ |

As shown in Tables 1 and 2, it was confirmed that the insulated wires in Examples 1 to 12 of the invention having an insulation covering thickness equivalent to that in the conventional technique (about 150 μm) have high partial discharge inception voltage of not less than 1700 Vp in a 25° C. environment and also have high partial discharge inception voltage of not less than 1500 Vp in a 150° C. environment. Furthermore, in the evaluation of adhesion, it was confirmed that the insulated wires in Examples 1 to 12 have necessary and sufficient characteristics. It is understood that adhesion is further improved especially in Examples 3, 4 and 7 to 12 in which the conductor temperature is not less than 250° C. as compared to Examples 1, 2, 5 and 6 in which the conductor temperature is less than 250° C.

On the other hand, as shown in Table 3, Comparative Examples 1 and 2 of which component of the first insulation covering layer is out of the defined range of the invention could not satisfy either requirement of adhesion or that of partial discharge inception voltage. In addition, in Comparative Examples 3 and 4 in which the component of the first insulation covering layer is also out of the defined range of the invention, partial discharge inception voltage obviously decreased in both environmental temperatures and the requirements were not satisfied.

The above demonstrates that the insulated wires in Examples 1 to 12 have higher partial discharge inception voltage than the conventional technique in a wide temperature range while adhesion equivalent to that in a conventional technique is ensured between the conductor and the insulation covering (without decreasing adhesion between the conductor and the insulation covering).

What is claimed is:

1. An insulated wire, comprising:
a conductor, and
an insulation covering formed thereon,
wherein the insulation covering comprises:
a first insulation covering layer formed directly on the conductor and a second insulation covering layer formed on a periphery of the first insulation covering layer,
wherein the first insulation covering layer comprises a resin composition comprising a resin (A) comprising polyphenylene sulfide and a resin (B) comprising polyamide mixed at a mass ratio in a range of “30/70≦B/A≦90/10”, and
wherein the second insulation covering layer comprises a resin composition mainly comprising a resin (C) comprising polyphenylene sulfide or polyetheretherketone.

2. The insulated wire according to claim 1, wherein the resin composition of the second insulation covering layer further comprises a resin (D) comprising polyamide mixed in an amount of not more than 5 parts by mass relative to the resin (C).

3. The insulated wire according to claim 1, wherein the resin composition of the second insulation covering layer further comprises a resin (E) comprising polyolefin having a relative dielectric constant of less than 3.0 mixed to the resin (C) at a mass ratio of “5/95≦E/C≦50/50”.

4. The insulated wire according to claim 1, wherein the polyamide of the resin (B) has a melting point of not less than 280° C.

5. The insulated wire according to claim 2, wherein the polyamide of the resin (B) and the resin (D) has a melting point of not less than 280° C.

6. The insulated wire according to claim 1, wherein the resin (B) comprises one of nylon 46, nylon 6T, nylon 6I, nylon 9T and nylon M5T.

7. The insulated wire according to claim 2, wherein the resin (B) and the resin (D) each comprise one of nylon 46, nylon 6T, nylon 6I, nylon 9T and nylon M5T.

8. The insulated wire according to claim 1, wherein the first insulation covering layer is formed on the conductor being heated to not less than 250° C.

9. The insulated wire according to claim 1, wherein the resin (E) comprises one of polyethylene, ethylene-vinyl acetate copolymer, ethylene-ethyl acrylate copolymer, ethylene methyl acrylate copolymer, ethylene-glycidyl methacrylate copolymer, isotactic polypropylene, syndiotactic polypropylene and polymethylpentene.

10. The insulated wire according to claim 1, wherein the resin (A) is 10 parts to 70 parts by mass included in the first insulation covering layer.

11. The insulated wire according to claim 10, wherein the resin (C) is included 50 parts to 100 parts by mass in the second insulation covering layer.
